(19) United States
(12) Patent Application Publication
(10) Pub. No.: US 2012/0255417 A1
(43) Pub. Date: Oct. 11, 2012

(54) TOOL HAVING PREDETERMINED BREAK LOCATION

(76) Inventors: Uwe Frueh, Sonnenbuehl (DE); Rainer Mann, Aalen-Unterrombach (DE)

(21) Appl. No.: 13/440,308

(22) Filed: Apr. 5, 2012

(30) Foreign Application Priority Data
Apr. 5, 2011 (DE) 10 2011 016 662.9

(51) Int. Cl. B23D 61/18; B26D 1/30

(52) U.S. Cl. 83/835; 83/697

(57) ABSTRACT

Disclosed is a tool for sawing, grinding, cutting or rasping, for a hand-held power tool appliance driven in an oscillating manner, in particular for an electric power tool driven in an oscillating manner, wherein the tool comprises at least one predetermined break line, which allows a part of the tool to be broken off.

### CROSSREFERENCES TO RELATED APPLICATIONS

This application claims priority from German patent application Serial No. 10 2011 016 662.9, filed on Apr. 5, 2011, the entire contents of which is incorporated herein by reference.

### BACKGROUND OF THE INVENTION

The invention relates to a tool for a hand-held power tool appliance, in particular for sawing, grinding, cutting, scraping or rasping, in particular for an electric power tool oscillatingly driven.

A great variety of tool types that can be used in combination with oscillatory drives are known from the prior art. Such tools are used, in particular, for sawing, grinding, cutting, scraping or rasping. Known from EP 0 881 023 A2, for example, is a series of cutting or grinding tools that can be used in combination with an oscillatory drive, in particular to enable cuts to be made under conditions of restricted space, for example to enable rectangular recesses to be made, e.g. on frames, in particular by plunge cuts. A rectilinear cutting edge, for example, can be provided for this purpose, the cutting edge having a toothing that is adjoined on both sides, at an angle of less than 90°, by non-toothed lateral edges. The two lateral edges can also be disposed parallel to one another.

Various further variants of tools that can be used in combination with oscillatory drives are known.

The shape of these tools is in each case is directed to a particular application. Thus, for example, there are broad saw blades for longer cuts, and narrow saw blades for smaller cuts or small recesses. Or there are long tools and short tools for sawing workpieces of greater or lesser thickness.

### SUMMARY OF THE INVENTION

In view of this, the invention is a first object of the invention to disclose a tool for a hand-held power tool appliance, that allows to achieve a wide range of applications with only one tool.

It is a second object of the invention to disclose a tool, that is particularly suited to be oscillatingly driven, in particular for sawing, grinding, cutting, scraping or rasping, and that can be used to achieve a wide range of applications with only one tool.

It is a third object of the invention to disclose a tool that can still be used if it has become blunt.

It is a forth object of the invention to disclose a tool that can be adapted to different geometries in a very simple way.

According to one aspect, these and other objects are achieved by a tool for a hand-held power tool appliance that is oscillatingly driven, wherein the tool comprises:

at least one fastening region configured for fastening to a hand-held power tool appliance, and

at least one working region supported by the fastening region,

wherein the working region comprises at least one predetermined break location, configured for allowing breaking off part of the working region along the predetermined break location.

The object of the invention is thereby fully achieved.

This is because, according to the invention, the tool itself can be altered by breaking off a part along the predetermined break location or break line. The tool can thus be used in at least two different embodiments, namely, in the delivery state, in which the predetermined break location is still intact, and in an altered state, in which at least a part of the tool has been broken off along the predetermined break location. The tool is thereby altered such that the result during working is an altered mode of operation. If a plurality of predetermined break locations are provided, this makes it possible to provide a range of differing embodiments of a tool.

According to a further design of the invention, the tool has a working region, on which the at least one predetermined break location is realized.

In this case, the at least one predetermined break location can be used to alter the working region by breaking off a part of the tool.

The alteration in this case can be a reduction in the size of the working region by breaking off a part of the tool.

Furthermore, the tool can have a cutting edge that can be altered by breaking off the at least one part.

For example, the cutting edge can be shortened by breaking off the at least one part.

Differing widths of application, or differing cut widths, can be realized in this manner.

According to a further design of the invention, at least one predetermined break location extends along a cutting edge, in order to expose a new cutting edge when a part is broken off.

In this way, the tool can continue to be used, even if the cutting edge or a part of the cutting edge is already worn.

Furthermore, it is conceivable for the predetermined break location to extend along a cutting edge having a toothing that differs from that of a first cutting edge.

This makes it possible to use the tool with differing toothings, it being possible, by breaking off a part, to change from a cutting edge having a first toothing to a cutting edge having a second toothing. For example, it is possible to change from a cutting edge having a Japan toothing, which provides for a considerably more aggressive cut, to a standard toothing that is suitable for wood or metal.

According to a further design of the invention, at least one cutting edge is realized as a straight cutting edge.

Alternatively, at least one cutting edge can also be realized as a curved cutting edge.

According to a further design of the invention, a fastening region is provided, which has a fastening aperture for preferably positive connection to a power tool appliance driven in an oscillating manner.

This provides for a secure and permanent connection to the power tool appliance driven in an oscillating manner, for a variety of applications.

Furthermore, the tool can have a circular or arcuate working region, the at least one predetermined break location preferably defining a portion of a circle or a segment of a circle.

Thus, for instance, a round saw blade can be used in such a way that, in its delivery state, it can be used for sawing less closely to edge regions. If a part is then broken off along a predetermined break location, one or more straight edges can thus be produced, thereby making it possible to work more closely to edge regions. Or it is possible to expose another cutting edge, which is located on a lesser diameter and thus has a greater curvature.

The predetermined break location is preferably constituted by a material weakening or by at least one through-hole with at least one web remaining.

The predetermined break location in this case can be formed, for instance, by a laser treatment, an erosive treatment, a stamping process or a grinding treatment.

This enables the predetermined break location to be produced in a simple manner. Clearly, in this case, this predetermined break location is to be made such that there is no risk of the tool breaking off at the predetermined break location during normal use. If there are through-holes, the remaining webs must provide adequate robustness.

It is understood that the above-mentioned features of the invention and those yet to be explained in the following can be applied, not only in the respectively specified combination, but also in other combinations or on its own, without departing from the scope of the present invention.

### BRIEF DESCRIPTION OF THE DRAWINGS

Further features and advantages of the invention are disclosed by the following description, preferred exemplary embodiments being disclosed with reference to the drawing, wherein:

FIG. 1 shows a top view of a first embodiment of a tool according to the invention;

FIG. 2 shows a top view of a second embodiment of a tool according to the invention, in a representation enlarged in comparison with the representation according to FIG. 1, and

FIG. 3 shows a top view of a third embodiment of a tool according to the invention.

### DETAILED DESCRIPTION OF PREFERRED EMBODIMENTS

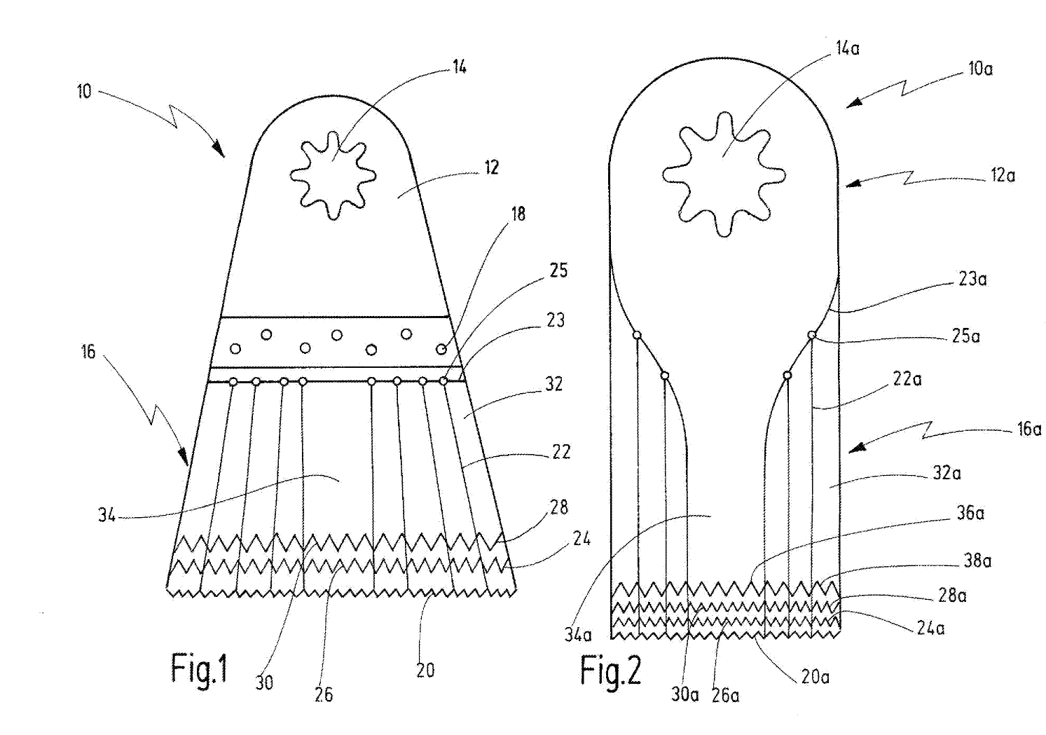

In FIG. 1, a first embodiment of a tool according to the invention is represented in a top view and denoted as a whole by the reference numeral 10. The tool 10 is configured as a sawing tool, which is used in combination with an electric power tool oscillatingly driven by means of an oscillatory drive.

Such oscillatory drives are known, for example, from the aforementioned EP 0 881 023 A1. The output shaft of the oscillatory drive in this case is made to oscillate about its longitudinal axis, this being at an oscillation frequency that is, for instance, between 5,000 and 25,000 oscillations per minute, and at a pivoting angle that is, for instance, between 0.5° and 5°. In order to ensure that the tool 10 is securely fastened to the output shaft of the associated oscillatory drive, the tool 10 is provided with a fastening region 12, on which a fastening aperture 14 is provided. The shape of the fastening aperture 14 matches an associated shape of the output shaft of the oscillatory drive, in order thereby to ensure a positive connection. The fastening apertures 14 can be of any shape, for instance having a plurality of outward-facing recesses or rounded tips, adjacent recesses or rounded tips being connected to one another via curved portions that extend towards the central axis, as known, for instance, from EP 1 213 107 A1, which hereby is fully included by reference.

Alternatively, any other shape can be provided, for example a polygon, a star shape, etc. Finally, it is also possible for the fastening aperture to be designed merely in the form of a circle, provided that no positive connection to the output shaft of the oscillatory drive is desired.

The tool 10 additionally has a working region 16, which can be configured integrally with the fastening region 12 or, as indicated in the present case in FIG. 1, connected to the same via a sequence of spot welds 18. If a two-part embodiment is selected, different materials and production methods can be used for the fastening region 12, on the one hand, and for the working region 16, on the other hand, which may allow more cost-effective production or greater efficiency. In addition, an offset (not represented) can be provided between the fastening region 12 and the working region 16.

In its outer shape, the tool 10 represented in FIG. 1 corresponds to the shape known from FIG. 2 of EP 0 881 023 A2. The tool 10 thus has a working region 16 having a straight cutting edge 20, which comprises a toothing. Adjoining the straight cutting edge 20 at both ends are non-toothed lateral edges, each of which, with the cutting edge 20, encloses an angle that is less than 90°, for example approximately 70° to 85°. These two angles are equal, such that the tool 10 as a whole is symmetrical in its structure.

According to the invention, a plurality of predetermined break locations are provided on both sides of a central, rectangular region 34 on the working region. For example, on one side, a predetermined break location extending out from the cutting edge 20, parallel to the outer edge, is denoted by 22, which predetermined break location terminates in a point 25 and from which a further predetermined break location 23 extends as far as the lateral edge. The predetermined break location 22 and the associated predetermined break location 23 can be used to break off the part 32 of the tool 10 delimited thereby, for example with the aid of combination pliers. This then results in a tool 10 that has been reduced in size and on which the cutting edge 20 has been shortened by a corresponding amount. When used as a saw, this means correspondingly shorter saw cuts, for instance when a plunge cut is made in solid material.

In addition, further, subsequent predetermined break locations on the same side and/or on the opposite side can be used to reduce the size of the working region 16 of the tool 10 accordingly, as can be seen from FIG. 1.

In this way, it is possible to effect differing cut widths on the cutting edge 20 on the working region 16. A minimum cut width remains when all regions bordered by predetermined break locations have been parted off on both sides of the central region 34. There then remains a central, rectangular region 34 having, on both sides, straight lateral edges that are parallel to one another.

Besides reducing the working region 16, the parting-off of parts 32 can also be used to renew the cutting edge, or a part thereof, when the cutting edge has become blunt.

Particularly in the case of the embodiment according to FIG. 1, it must be taken into account that the peripheral regions of the cutting edge 20 become abraded more rapidly than the central part of the cutting edge. Thus, the cutting edge 20 can be reduced in size by parting off outer regions that have become blunt, such that work can then be better performed with the still remaining part of the working region 16.

In addition or as an alternative to this, a cutting edge 24, or a plurality of cutting edges 24, 28, can be provided, which is/are preferably parallel to the first cutting edge 20 and which is/are likewise realized with a toothing. A predetermined break location 24, 28 provided along the cutting edge 26 and 30, respectively, thus enables an outer part of the cutting edge 20 to be broken off along the respectively new cutting edge 26 and 30, respectively. A new cutting edge 26 or 30 is thus produced.

The new cutting edges 26 and 30 can be realized so as to be identical to the first cutting edge 20, having an identical toothing, or they can have a toothing that differs from the latter, as shown in FIG. 1.

During use, the entire predetermined break location 24 can be parted off in its entirety along the cutting edge 26, such that a continuous cutting edge 26, extending in relation to the first cutting edge 20, is obtained. In the present case, the second cutting edge 26 has a toothing that differs from the first cutting edge 20, e.g. a Japan toothing. However, it can also be realized so as to have an identical toothing.

Extending parallel thereto there is a further predetermined break location 28, which defines a second cutting edge 30, again having a corresponding toothing.

Instead of parting off the entire predetermined break location 24 over its entire length, it is also possible to part off individual parts or a plurality of parts thereof.

A modification of the embodiment previously described with reference to FIG. 1 is represented in FIG. 2, and denoted as a whole by the reference numeral 10a. The tool 10a again has a fastening region 12a, which comprises a fastening aperture 14a and which is adjoined by a working region 16a. In the case of the embodiment according to FIG. 2, the fastening region 12a and the working region 16a are designed so as to constitute a single piece and to lie in one plane. In the initial form, according to FIG. 2 a tool 10a is obtained that has a rectangular working region 16a, on which there is realized a straight cutting edge 20a provided with a toothing. Extending out from the cutting edge 20a there are non-toothed lateral edges, which are parallel to one another and which graduate into the fastening region 12a.

Extending parallel to the cutting edge 20a, at a short distance therefrom, there are three further cutting edges 26a, 30a, 36a, realized on which there are predetermined break locations 24a, 28a, 38a.

As described previously with reference to FIG. 1, after the cutting edge 20a has become worn, for instance, the second cutting edge 24a, parallel to the latter, can thus be exposed in that the predetermined break location 24a is broken off over its full length, such that the cutting edge 26a, which extends parallel to the cutting edge 20a, is exposed in its entirety. The cutting edge 26a can be realized so as to differ from the cutting edge 20a, as represented in FIG. 2, but it can also be of the same shape and size.

Provided in the center of the working region 16a is a central region 34a, which, starting from the cutting edge 20a, has two lateral edges that are parallel to one another, and which widen outwards on both sides via curved lines and finally graduate into the outer edges on the fastening region 12a. This central region 34a is delimited on both sides by a correspondingly shaped predetermined break location 23a. Thus, starting from the fastening region 12a having parallel outer edges and progressing along the predetermined break location 23a on both sides, a tapered central region 34a is obtained, again having parallel outer edges, which is connected on both sides to the outer edge of the fastening region 12a via the curved predetermined break location 23a. A total of three predetermined break locations, which are parallel to the outer edges and terminate at the cutting edge 20a, are provided on each side of the central region 34a. For these, one predetermined break location 22a is denoted on the right outer side. At a point 25a, this predetermined break location graduates into the curved predetermined break location 23a. An outer part 32a can thus be parted off by breaking off along the predetermined break location 22a and the predetermined break location 23a, starting from the point 25a. As a result, the working region 16a is made correspondingly narrower on this side, such that the new outer edge extends along the predetermined break location 22a and 23a. The other predetermined break locations that are parallel thereto can be broken off in a corresponding manner on one side or on both sides, such that a correspondingly narrower working region 16a is obtained.

As already explained above, as an alternative or in addition to this, one of the predetermined break locations 28a, 38a or 36a can be used to expose all or part of one of the cutting edges 26a, 30a or 36a.

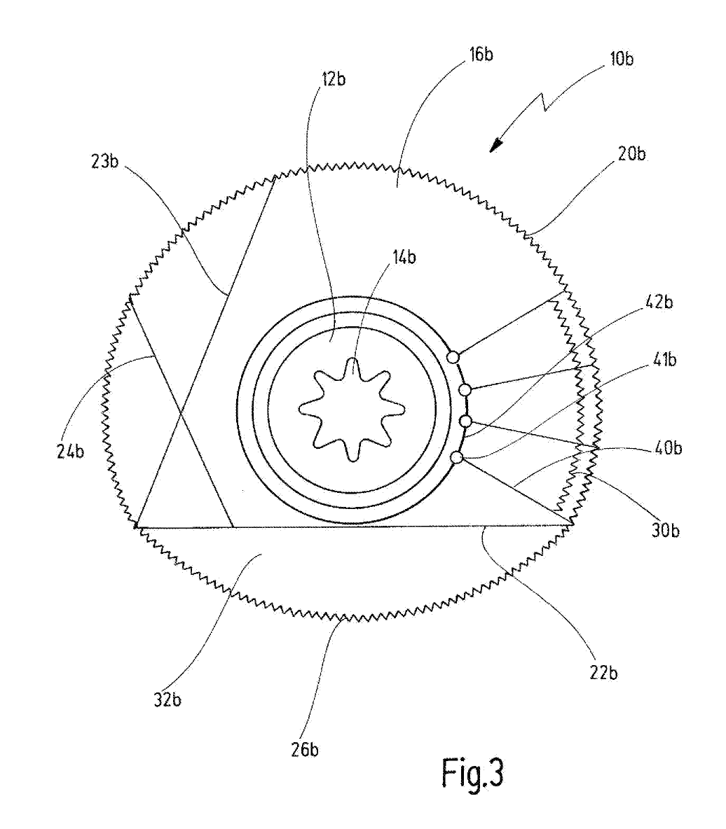

A further exemplary embodiment of the invention is represented in FIG. 3 and denoted as a whole by the reference numeral 10b. The tool 10b is basically circular in form and has a central fastening region 12b, again having a fastening aperture 14b, according to the shape explained previously with reference to FIG. 1.

The fastening region 12b is adjoined by an outer working region 16b. Realized on the periphery there is a circular cutting edge 20b, which has a toothing, and which extends, for instance, over 230° and which is delimited by a predetermined break location 22b that extends in the form of a chord and thus defines a segment of a circle. The periphery between the two points at which the predetermined break location 22b intersects the cutting edge 20b is closed by an arcuate cutting edge 26b, on which a toothing is realized. The cutting edge 26b, however, has a greater radius than the cutting edge 20b.

In the initial state, therefore, work can be performed with the tool 10b by using the cutting edge 26b if relatively long, but not very deep cuts are to be produced. If deeper cuts are to be produced, on the other hand, the remaining region of the cutting edge 20b is used. Breaking off the region 32b between the predetermined break location 22b and the cutting edge 26b produces a portion of a circle having a straight break edge. Further predetermined break locations that extend in a straight manner are denoted by 23b and 24b. The predetermined break location 23b starts from one end of the predetermined break location 22b and extends towards the cutting edge 20b. This predetermined break location 23b is of approximately the same length as the predetermined break location 22b, or is somewhat shorter. A further predetermined break location 24b starts from a region of the cutting edge 20b, between the point at which the predetermined break location 23b intersects the cutting edge 20b and the point at which the predetermined break location 23b meets the predetermined break location 22b at the cutting edge 20b, and ends on the predetermined break location 22b. If all predetermined break locations 22b, 23b, 24b are broken off, a tool 10b remains, which has an arcuate cutting edge 20b and which is delimited by a plurality of straight break-off edges along the lines 22b, 23b, 24b.

Also shown in FIG. 3 are regions in the form of a sector of a circle, which, starting from the cutting edge 20b, extend as far as an arc, concentric with the latter, at the transition to the fastening region 12b, and which are delimited by predetermined break locations 40b extending in the radial direction. These predetermined break locations each graduate, via points 41b, into a predetermined break location 42b extending in the form of a sector of a circle.

In addition, in this region, there is a cutting edge 30b that extends concentrically in relation to the outer cutting edge 20b. The latter can again be broken off, by breaking off the outer part along a predetermined break location extending along the cutting edge 30b, such that the cutting edge 30b in this region is reduced in size concentrically in relation to the outer cutting edge 20b and extends concentrically in relation to the outer cutting edge 20b.

It is understood that any embodiments of predetermined break locations, differing from the exemplary embodiments represented, are possible in order to create working regions of reduced size, either having cutting edges that are shortened in comparison with the original cutting edge, or, alternatively, having cutting edges that are altered in comparison with the original cutting edge, and that might extend parallel to or deviate from the original cutting edge.

What is claimed is:

1. A tool for a hand-held power tool appliance that is oscillatingly driven, said tool comprising:
at least one fastening region comprising a fastening opening configured for fastening to an oscillatory drive of said hand-held power tool appliance, and
at least one working region supported by said fastening region;
wherein said working region comprises at least one a cutting edge which can be altered by breaking off part of said working region along a predetermined break line.

2. The tool of claim 1, which is configured as a tool selected from the group consisting of a sawing tool, a grinding tool, a cutting tool, a scraping tool, and a rasping tool.

3. The tool of claim 1, wherein said cutting edge can be shortened by breaking off said part of said working region.

4. The tool of claim 1, wherein said predetermined break line extends along said cutting edge provided on said working region, so as to allow exposure of a new cutting edge when a part is broken off along said predetermined break line.

5. The tool of claim 1, comprising at least one straight cutting edge.

6. The tool of claim 1, comprising at least one curved cutting edge.

7. The tool of claim 1, wherein said cutting edge comprises a toothing.

8. The tool of claim 1, wherein said at least one predetermined break line extends along a cutting edge having a toothing that differs from that provided on a first cutting edge.

9. The tool of claim 1, wherein said working region is configured as a circular or arcuate working region, wherein said at least one predetermined break line defines at least a portion of a circle.

10. The tool of claim 1, wherein said at least one predetermined break line is defined by a material weakening provided on said working region.

11. The tool of claim 1, wherein said at least one predetermined break line is defined by at least one through-hole provided on said working region, with at least one web remaining on said working region.

12. The tool of claim 1, wherein said predetermined break line is formed by a treatment selected from the group consisting of a laser treatment, an erosive treatment, a stamping process, and a grinding treatment.

13. A tool for a hand-held power tool appliance that is oscillatingly driven, said tool comprising:
at least one fastening region configured for fastening to an oscillatory drive of said hand-held power tool appliance, and
at least one working region supported by said fastening region,
wherein said working region comprises at least one predetermined break location, configured for allowing breaking off part of said working region along said predetermined break location;
wherein said at least one predetermined break location is defined by a feature selected from the group formed by a material weakening provided on said working region and at least one through-hole provided on said working region, with at least one web remaining on said working region.

14. The tool of claim 13, wherein said working region is configured as a circular or arcuate working region, wherein said at least one predetermined break location defines at least a portion of a circle or an arc.

15. A tool for a hand-held power tool appliance that is oscillatingly driven,
said tool comprising:
at least one fastening region configured for fastening to said hand-held power tool appliance, and
at least one working region supported by said fastening region,
wherein said working region comprises at least one predetermined break location, configured for allowing breaking off part of said working region along said predetermined break location.
